(19) United States
(12) Patent Application Publication
(10) Pub. No.: US 2026/0116432 A1
(43) Pub. Date: Apr. 30, 2026

(54) SYSTEM AND METHOD FOR A THREAT ASSESSMENT OF A DRIVER

(71) Applicant: Torc Robotics, Inc., Blacksburg, VA (US)

(72) Inventors: William Gray Davis, Austin, TX (US); Akshay Pai Raikar, Austin, TX (US); Armenio Jose Rivero, Austin, TX (US); Pablo Smith, Spicewood, TX (US); Hamzah Imtiaz Khan, Austin, TX (US); Joseph R. Fox-Rabinovitz, Austin, TX (US)

(21) Appl. No.: 18/927,596

(22) Filed: Oct. 25, 2024

(51) Int. Cl. B60W 60/00; B60W 50/06

(52) U.S. Cl. CPC B60W 60/0016; B60W 50/06; B60W 2556/10

(57) ABSTRACT

A system positioned in an autonomous vehicle includes a plurality of sensors, and a processor coupled to a memory and configured to: (i) based upon sensor data, determine an unsafe maneuver and a type of unsafe maneuver of a vehicle; (ii) upon a risk assessment profile for the vehicle existing in the database, (a) retrieve, from the risk assessment profile, historical data including a respective timestamp of one or more types of unsafe maneuver and the one or more types of unsafe maneuver; (b) update the historical data to further include data corresponding to the type of unsafe maneuver and the timestamp when the type of unsafe maneuver was performed; and (c) compute the threat assessment score that is revised based upon updated historical data; and (iii) upon the threat assessment score being above a threshold value, perform an action that increase safety of the autonomous vehicle.

### TECHNICAL FIELD

The field of the disclosure relates generally to behaviors and planning technologies, more specifically, a threat assessment of a driver using statistical methods and based upon an observed driving pattern of the driver.

### BACKGROUND OF THE INVENTION

Autonomous vehicles employ fundamental technologies such as, perception, localization, behaviors and planning, and control. Perception technologies enable an autonomous vehicle to sense and process its environment. Perception technologies process a sensed environment to identify and classify objects, or groups of objects, in the environment, for example, pedestrians, vehicles, or debris. Localization technologies determine, based on the sensed environment, for example, where in the world, or on a map, the autonomous vehicle is. Localization technologies process features in the sensed environment to correlate, or register, those features to known features on a map. Localization technologies may rely on inertial navigation system (INS) data. Behaviors and planning technologies determine how to move through the sensed environment to reach a planned destination. Behaviors and planning technologies process data representing the sensed environment and localization or mapping data to plan maneuvers and routes to reach the planned destination for execution by a controller or a control module. Controller technologies use control theory to determine how to translate desired behaviors and trajectories into actions undertaken by the vehicle through its dynamic mechanical components. This includes steering, braking and acceleration.

On the road, some drivers operate their vehicle in an unsafe manner. Other traffic participants or drivers operating their vehicle in proximity of such drivers need to remain careful about a sudden move by such drivers to increase their safety and safety of their vehicles. Human drivers can identify such drivers based upon observing a driving pattern of such drivers and can take an action that increases their and their vehicle's safety.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY OF THE INVENTION

In one aspect, a system positioned in an autonomous vehicle is disclosed. The system includes a plurality of sensors, at least one memory configured to store instructions, and at least one processor coupled to the at least one memory. The at least one processor is configured to execute the stored instructions to perform operations including: (i) based upon sensor data from the plurality of sensors, determining an unsafe maneuver and a type of unsafe maneuver of a vehicle; (ii) determining whether a risk assessment profile for the vehicle exists in a database; (iii) upon determining that the risk assessment profile for the vehicle does not exist in the database, (a) generating the risk assessment profile for the vehicle, wherein the risk assessment profile comprises data corresponding to the unsafe maneuver and the type of unsafe maneuver, one or more vehicle identifications of the vehicle, and a timestamp when the unsafe maneuver and the type of unsafe maneuver was performed; and (b) computing a threat assessment score based upon the type of unsafe maneuver; (iv) upon determining the risk assessment profile for the vehicle exists in the database, (a) retrieving, from the risk assessment profile, historical data including a respective timestamp of one or more types of unsafe maneuver and the one or more types of unsafe maneuver; (b) updating the historical data to further include data corresponding to the type of unsafe maneuver and the timestamp when the type of unsafe maneuver was performed; and (c) computing the threat assessment score that is revised based upon updated historical data; and (v) upon determining that the threat assessment score is at or above a threshold value, performing an action that increase safety of the autonomous vehicle. The database is communicatively coupled with the at least one processor.

In another aspect, a computer-implemented method is disclosed. The method includes: (i) determining, based upon sensor data from a plurality of sensors, an unsafe maneuver and a type of unsafe maneuver of a vehicle; (ii) determining whether a risk assessment profile for the vehicle exists in a database; (iii) upon determining that the risk assessment profile for the vehicle does not exist in the database, (a) generating the risk assessment profile for the vehicle, wherein the risk assessment profile comprises data corresponding to the unsafe maneuver and the type of unsafe maneuver, one or more vehicle identifications of the vehicle, and a timestamp when the unsafe maneuver and the type of unsafe maneuver was performed; and (b) computing a threat assessment score based upon the type of unsafe maneuver; (iv) upon determining the risk assessment profile for the vehicle exists in the database, (a) retrieving, from the risk assessment profile, historical data including a respective timestamp of one or more types of unsafe maneuver and the one or more types of unsafe maneuver; (b) updating the historical data to further include data corresponding to the type of unsafe maneuver and the timestamp when the type of unsafe maneuver was performed; and (c) computing the threat assessment score that is revised based upon updated historical data; and (v) upon determining that the threat assessment score is at or above a threshold value, performing an action that increase safety of an autonomous vehicle.

In yet another aspect, an autonomous vehicle including a plurality of sensors, at least one memory configured to store instructions, and at least one processor coupled to the at least one memory is disclosed. The at least one processor is configured to execute the stored instructions to perform operations including: (i) based upon sensor data from the plurality of sensors, determining an unsafe maneuver and a type of unsafe maneuver of a vehicle; (ii) determining whether a risk assessment profile for the vehicle exists in a database; (iii) upon determining that the risk assessment profile for the vehicle does not exist in the database, (a) generating the risk assessment profile for the vehicle, wherein the risk assessment profile comprises data corresponding to the unsafe maneuver and the type of unsafe maneuver, one or more vehicle identifications of the vehicle, and a timestamp when the unsafe maneuver and the type of unsafe maneuver was performed; and (b) computing a threat assessment score based upon the type of unsafe maneuver; (iv) upon determining the risk assessment profile for the vehicle exists in the database, (a) retrieving, from the risk assessment profile, historical data including a respective timestamp of one or more types of unsafe maneuver and the one or more types of unsafe maneuver; (b) updating the historical data to further include data corresponding to the type of unsafe maneuver and the timestamp when the type of unsafe maneuver was performed; and (c) computing the threat assessment score that is revised based upon updated historical data; and (v) upon determining that the threat assessment score is at or above a threshold value, performing an action that increase safety of the autonomous vehicle. The database is communicatively coupled with the at least one processor.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1. is a schematic view of an autonomous truck;

FIG. 2 is a block diagram of the autonomous truck shown in FIG. 1;

FIG. 3 is a block diagram of an example computing system; and

FIG. 4 is an example flow-chart of a method of performing a threat assessment of a driver.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing.

Some structural or method features may be shown in specific arrangements and/or orderings in the drawings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments, and, in some embodiments, it may not be included or may be combined with other features.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure.

One or more of the following terms may be used in the disclosure, and their definition is provided below.

An autonomous vehicle: An autonomous vehicle is a vehicle that is able to operate itself to perform various operations such as controlling or regulating acceleration, braking, steering wheel positioning, and so on, without any human intervention. An autonomous vehicle has an autonomy level of level-4 or level-5 recognized by National Highway Traffic Safety Administration (NHTSA).

A semi-autonomous vehicle: A semi-autonomous vehicle is a vehicle that is able to perform some of the driving related operations such as keeping the vehicle in lane and/or parking the vehicle without human intervention. A semi-autonomous vehicle has an autonomy level of level-1, level-2, or level-3 recognized by NHTSA.

A non-autonomous vehicle: A non-autonomous vehicle is a vehicle that is neither an autonomous vehicle nor a semi-autonomous vehicle. A non-autonomous vehicle has an autonomy level of level-0 recognized by NHTSA.

Mission control: Mission control, as described in the present disclosure, refers to one or more application servers, and one or more database servers communicatively coupled with each other and one or more autonomous vehicles of a fleet. Mission control receives sensor data collected by one or more sensors of the one or more autonomous vehicles of the fleet and transmit data, e.g., threat assessment scores and/or driving histories of one or more vehicles on the road, to the one or more autonomous vehicles of the fleet.

As described herein, some drivers operate their vehicle in an unsafe manner, which requires other traffic participants or drivers operating their vehicle in proximity of such drivers to remain extra cautious because a sudden move by such drivers may put their safety and safety of their vehicles at a higher risk. Human drivers can identify such drivers based upon observing a driving pattern of such drivers and can take an action that increases their and their vehicle's safety.

The disclosed systems and methods detect or identify aggressive driving or unsafe maneuvers of various vehicles in the proximity of an autonomous vehicle using sensor data, and processing the sensor data through various machine learning techniques or a neural network-based approach along with statistical methods. The machine learning techniques may include, but are not limited to, random forests, support vector machines, Gaussian mixture models, support vector regression, or partial least squares regression. Aggressive driving or unsafe maneuvers of various vehicles in the proximity of the autonomous vehicle may be detected or identified using deep learning neural network or a convolutional neural network (CNN).

The statistical methods are used to build a profile for each driver based upon a number of encounters of aggressive driving and a type of each encountered aggressive driving. Based upon the number of encounters of aggressive driving and the type of each encountered aggressive driving, a threat assessment score may be generated corresponding to each driver or vehicle driving aggressively. Accordingly, the threat assessment score may increase with a detected aggressive driving incident and, conversely, no detection or occurrence of the aggressive driving incident by a driver or a vehicle over a predetermined time duration may result in a decrease in the threat assessment score.

In some embodiments, one or more of, swerving without causing a lane change, a large amount of acceleration or deceleration, tailgating, changing a lane in the middle of an intersection, changing a lane without a turn signal indication, driving above a posted speed limit by a threshold speed, driving below the posted speed limit by another threshold speed, large speed differentials compared to speed of other vehicles on the road, and frequent lane changes over a predetermined time duration, etc., are considered as aggressive driving incidents. Accordingly, various machine learning techniques or the neural network-based approach may be trained to detect one or more of the aggressive driving incidents described herein. In some embodiments, various machine learning techniques or the neural network-based approach may be trained using the Second Strategic Highway Program (SHRP2) dataset, which includes 58 labels indicating different aggressive driver behavior.

In some embodiments, using sensors, including one or more radio detection and ranging (RADAR) sensors, one or more cameras, and/or one or more light detection and ranging (LiDAR) sensors, vehicle acceleration in the longitudinal direction versus time in units of g, vehicle acceleration in the lateral direction versus time in units of g, vehicle acceleration in the vertical direction versus time in units of g of other vehicles may be measured or computed. Additionally, vehicle angular velocity around the longitudinal axis, the lateral axis, and the vertical axis in units of degrees per second may be measured or computed. Further, whether a particular vehicle is a specific time distance away from another vehicle in the longitudinal direction is also determined based upon the computed vehicle acceleration in the longitudinal direction. Similarly, whether a particular vehicle is a specific time distance away from another vehicle in the lateral direction is also determined based upon the computed vehicle acceleration in the lateral direction. Vehicle acceleration in the longitudinal direction, lateral direction, or vertical direction, and vehicle angular velocity around the longitudinal axis, lateral axis, and the vertical axis are analyzed or processed through the neural network-based approach, e.g., the deep learning neural network or CNN, or various machine-learning techniques to determine whether a particular vehicle is aggressively driving or performing unsafe maneuvers, such as swerving without causing a lane change, a large amount of acceleration or deceleration, tailgating, driving above a posted speed limit by a threshold speed, driving below the posted speed limit by another threshold speed, and large speed differentials compared to speed of other vehicles on the road, etc. Further, based upon processing the sensor data of one or more sensors including, but not limited to, one or more cameras, using the neural network-based approach, or various machine-learning techniques, whether the particular vehicle is aggressively driving or performing unsafe maneuvers, such as changing a lane in the middle of an intersection, changing a lane without a turn signal indication, and frequent lane changes over a predetermined time duration, etc., is determined.

In some embodiments, a particular type of aggressive driving or unsafe maneuver of a vehicle may be associated with the vehicle based upon one or more vehicle identifications including a color of the vehicle, a make and a model of the vehicle, or a license plate of the vehicle. In some embodiments, and by way of a non-limiting example, the observed particular type of aggressive driving or unsafe maneuver of the vehicle with one or more vehicle identifications may be reported to mission control for computing a threat assessment score for the vehicle. Additionally, or alternatively, the observed particular type of aggressive driving or unsafe maneuver of the vehicle with one or more vehicle identifications may be reported to other autonomous vehicles in vicinity of the autonomous vehicle that observed the particular type of aggressive driving or unsafe maneuver of the vehicle.

Based at least in part upon the particular type of aggressive driving or unsafe maneuver and based at least in part a number of times the particular type of aggressive driving or unsafe maneuver performed by the vehicle in a predetermined time duration, the threat assessment score may be computed. By way of a non-limiting example, the predetermined time duration may be different for different type of aggressive driving or unsafe maneuver. Further, if the particular type of aggressive driving or unsafe maneuver is not performed by the vehicle after its last occurrence for another predetermined time duration, the threat assessment score of the vehicle may be recomputed, and the recomputed threat assessment score may be reduced. By way of a non-limiting example, a reduction in the threat assessment score may be exponential in nature with passing of time without reoccurrence of the particular type of aggressive driving or unsafe maneuver.

Accordingly, tracking or monitoring the threat assessment score across multiple timescales provides useful information. For example, a high value of the threat assessment score on both a long-time scale and a short-time scale may suggest that the driver has a consistent trend for aggressive driving. However, a low value of the threat assessment score on a long-time scale with a high value of the threat assessment score on a short-time scale may suggest the driver is not a habitual aggressive driver.

The threat assessment score of the vehicle is transmitted or broadcasted to autonomous vehicles of a fleet along with the one or more vehicle identifications. Similarly, the recomputed threat assessment score of the vehicle is also transmitted or broadcasted to autonomous vehicles of the fleet along with the one or more vehicle identifications. Accordingly, autonomous vehicles on the road in proximity of the vehicle may retrieve a current value of the threat assessment score of the vehicle based upon the one or more vehicle identifications. If the current value of the threat assessment score of the vehicle satisfies a criterion, e.g., the threat assessment score at or above a specific value, the autonomous vehicle may take a cautionary action such that safety of the autonomous vehicle is increased.

In some embodiments, mission control may remove the vehicle data corresponding to the threat assessment score when the threat assessment score satisfies another criterion, e.g., the threat assessment score is at or below another specific value. Additionally, mission control may also communicate with other autonomous vehicles of the fleet to remove the vehicle data corresponding to the threat assessment score for the vehicle.

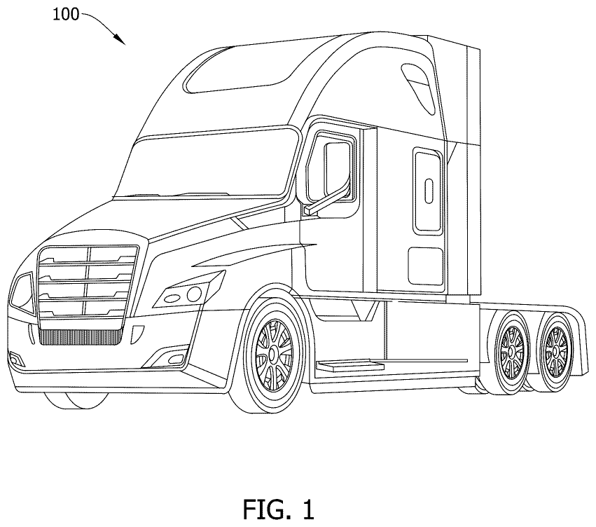

FIG. 1 illustrates a vehicle 100, such as a truck that may be conventionally connected to a single or tandem trailer to transport the trailer (not shown in FIG. 1) to a desired location. The vehicle 100 includes a cabin that can be supported by, and steered in the required direction, by front wheels and rear wheels that are partially shown in FIG. 1. Front wheels are positioned by a steering system that includes a steering wheel and a steering column (not shown in FIG. 1). The steering wheel and the steering column may be located in the interior of cabin.

The vehicle 100 may be an autonomous vehicle, in which case the vehicle 100 may omit the steering wheel and the steering column to steer the vehicle 100. Rather, the vehicle 100 may be operated by an autonomy computing system (not shown in FIG. 1) of the vehicle 100 based on data collected by a sensor network (not shown in FIG. 1) including one or more sensors.

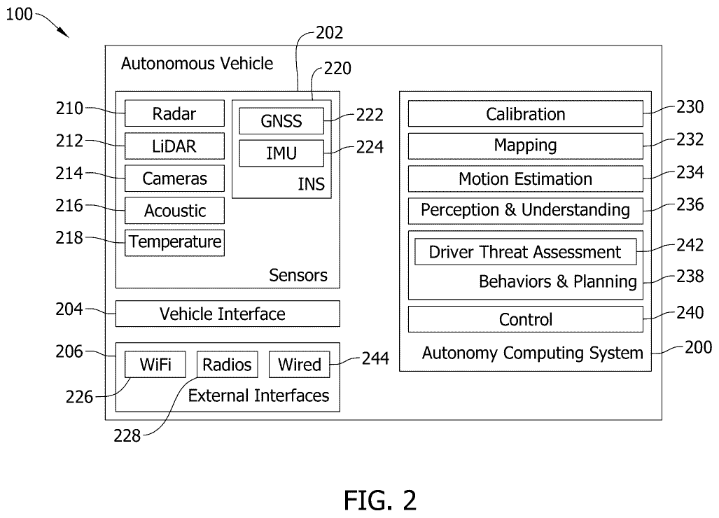

FIG. 2 is a block diagram of autonomous vehicle 100 shown in FIG. 1. In the example embodiment, autonomous vehicle 100 includes autonomy computing system 200, sensors 202, a vehicle interface 204, and external interfaces 206.

In the example embodiment, sensors 202 may include various sensors such as, for example, radio detection and ranging (RADAR) sensors 210, light detection and ranging (LiDAR) sensors 212, cameras 214, acoustic sensors 216, temperature sensors 218, or inertial navigation system (INS) 220, which may include one or more global navigation satellite system (GNSS) receivers 222 and one or more inertial measurement units (IMU) 224. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of autonomous vehicle 100 and its proximity. As described in further detail below, these signals may be used by autonomy computing system 200 to determine how to control operations of autonomous vehicle 100.

Cameras 214 are configured to capture images of the environment surrounding autonomous vehicle 100 in any aspect or field of view (FOV). The FOV can have any angle or aspect such that images of the areas ahead of, to the side, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, the image data generated by cameras 214 may be sent to autonomy computing system 200 or other aspects of autonomous vehicle 100 or mission control (a hub) or both.

LiDAR sensors 212 generally include a laser generator and a detector that send and receive a LiDAR signal such that LiDAR point clouds (or “LiDAR images”) of the areas ahead of, to the side, behind, above, or below autonomous vehicle 100 can be captured and represented in the LiDAR point clouds. RADAR sensors 210 may include short-range RADAR (SRR), mid-range RADAR (MRR), long-range RADAR (LRR), or ground-penetrating RADAR (GPR). One or more sensors may emit radio waves, and a processor may process received reflected data (e.g., raw RADAR sensor data) from the emitted radio waves. In some embodiments, the system inputs from cameras 214, RADAR sensors 210, or LiDAR sensors 212 may be used in combination to identify one or more construction markers (or nodes) around autonomous vehicle 100.

GNSS receiver 222 is positioned on autonomous vehicle 100 and may be configured to determine a location of autonomous vehicle 100, which it may embody as GNSS data. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment.

IMU 224 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 224 may measure an acceleration, angular rate, or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100.

In the example embodiment, autonomy computing system 200 employs vehicle interface 204 to send commands to the various aspects of autonomous vehicle 100 that actually control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5G, Bluetooth, etc.).

In some embodiments, external interfaces 206 may be configured to communicate with an external network via a wired connection 244, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically, or manually) via external interfaces 206 or updated on demand. In some embodiments, autonomous vehicle 100 may deploy with all of the data it needs to complete a mission (e.g., perception, localization, and mission planning) and may not utilize a wireless connection or other connections while underway.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, a control module or controller 240, and a driver threat assessment module 242. The driver threat assessment module 242, for example, may be embodied within another module, such as behaviors and planning module 238, perception and understanding module 236, or separately. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100.

The threat assessment module 242 determines whether a specific maneuver performed by another driver on the road is a type of aggressive driving or unsafe maneuver based upon various machine learning techniques or the neural network-based approach described herein. Further, if it determined that the specific maneuver performed by the other driver on the road is a type of aggressive driving or unsafe maneuver, the threat assessment module 242 computes a threat assessment score for the vehicle based upon a history of prior aggressive driving or unsafe maneuver(s) performed by a driver of the vehicle and not yet removed from the database. As described herein, an incident corresponding to each different type of aggressive driving or unsafe maneuver is removed from the database if that unsafe maneuver is not repeated in a specific time duration, and, therefore, only incidents, which are not removed and associated with the vehicle are considered to compute a threat assessment score, as described herein.

The threat assessment module 242 may also report a specific incident of aggressive driving or unsafe maneuver to mission control or a law enforcement agency. For example, based upon sensor data, and processing of the sensor data using various machine learning techniques or the neural network-based approach, if it is determined that the particular vehicle is operated by a likely drunk driver, as the vehicle changed lanes in a short time without turning on a change lane indicator, and the vehicle is swerving inside a traffic lane more frequently than a normal swerving, the threat assessment module 242 may transmit vehicle identification data and data corresponding to the specific incident of aggressive driving or unsafe maneuver to mission control or a law enforcement agency via external interfaces 206. By way of a non-limiting example, mission control may report vehicle identification data and data corresponding to the specific incident of aggressive driving or unsafe maneuver to the law enforcement agency, or other autonomous vehicles in vicinity of the vehicle.

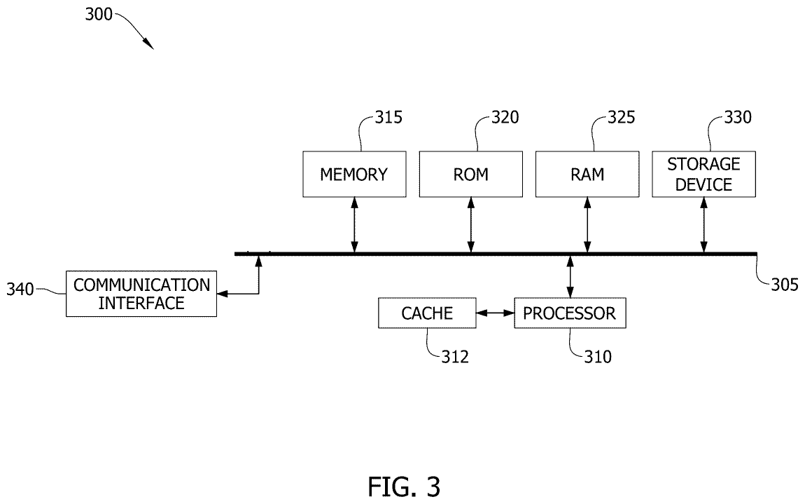

FIG. 3 illustrates an example computing system 300 that can implement various techniques, processes, functions, or methods described herein. The components of computing system 300 are shown in electrical communication with each other using a connection 305, such as a bus. The example computing system 300 includes a processing unit (CPU or processor) 310 and a computing device connection 305 that couples various computing device components, including computing device memory 315, such as a read only memory (ROM) 320 and a random-access memory (RAM) 325, and communication interface 340 to processor 310. The communication interface 340 may include one or more of a radio interface, an electronic sign board mounted on autonomous vehicle 100, a public address system or a loudspeaker positioned at autonomous vehicle 100. The radio interface may be configured for at least one of: (i) a vehicle-to-vehicle communication technique, (ii) citizens band radio frequencies; (iii) a Bluetooth signal; (iv) Wi-Fi; and (v) a short message service (SMS) technology.

Computing system 300 can include a cache 312 of high-speed memory connected directly with, in close proximity to, or integrated as part of processor 310. Computing system 300 can copy data from memory 315 and/or storage device 330 to cache 312 for quick access by processor 310. In this way, cache 312 can provide a performance boost that avoids processor 310 delays while waiting for data. These and other modules can control or be configured to control processor 310 to perform various actions. Other computing device memory 315 may be available for use as well. Memory 315 can include multiple different types of memory with different performance characteristics. Processor 310 can include any general-purpose processor, central processing unit (CPU), or graphics processing unit (GPU) in combination with a hardware or software provision configured to control processor 310 and stored in storage device 330, as well as any special-purpose processor where software instructions are incorporated into the processor design. Processor 310 may be a self-contained system, containing multiple cores or processors, a bus, memory controller, cache, etc. A multi-core processor may be symmetric or asymmetric.

Storage device 330 is a non-volatile memory and can be one or more of a hard disk or other types of computer readable media that can store data that are accessible by a computer, such as a magnetic cassette, flash memory card, solid state memory device, digital versatile disk, cartridge, RAM 325, ROM 320, or hybrids thereof. Memory 315 or storage device 330 can include software, code, firmware, etc., for controlling processor 310. Other hardware or software modules are contemplated. Memory 315 and storage device 330 are connected to computing device connection 305. In one aspect, a hardware module that performs a particular function can include the software component stored in a computer-readable medium in connection with the necessary hardware components, such as processor 310, computing device connection 305, and so forth, to carry out the function. In the example embodiment, processor 310 may be programmed by encoding an operation or function using one or more executable instructions and providing the executable instructions in memory 315 or storage device 330.

In operation, a computer executes computer-executable instructions embodied in one or more computer-executable components stored on one or more computer-readable media to implement aspects of the disclosure described or illustrated herein. The order of execution or performance of the operations in embodiments of the disclosure illustrated and described herein is not essential, unless otherwise specified. That is, the operations may be performed in any order, unless otherwise specified, and embodiments of the disclosure may include additional or fewer operations than those disclosed herein. For example, it is contemplated that executing or performing a particular operation before, contemporaneously with, or after another operation is within the scope of aspects of the disclosure.

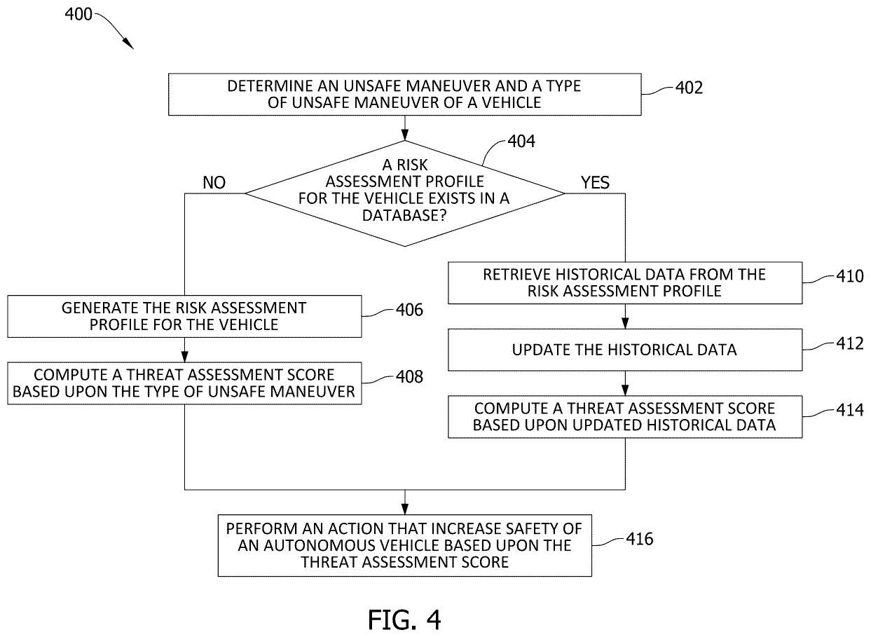

FIG. 4 is an example flow-chart 400 of method operations for determining a threat assessment score for a vehicle that is identified as driving aggressively or performing an unsafe maneuver of the vehicle. The method operations may be performed by a system positioned in an autonomous vehicle or an application server at mission control. Mission control (or the application server) may be communicatively coupled with one or more autonomous vehicles and receive sensor data collected by one or more sensors of the one or more autonomous vehicles. As described herein, the system, the autonomous vehicle, or the application server may further include at least one memory storing instructions, and at least one processor communicatively coupled with the at least memory. The at least one processor may be communicatively coupled with a database. The database may be a local database such as a database positioned in the system, the autonomous vehicle, or the application server performing the method operations. Alternatively, or additionally, the database may be a remoted database that is not positioned in the system, the autonomous vehicle, or the application server performing the method operations.

The method operations include determining 402 an unsafe maneuver and a type of unsafe maneuver of a vehicle. The unsafe maneuver and the type of unsafe maneuver of the vehicle is determined based upon sensor data collected by a plurality of sensors (e.g., one or more sensors). The plurality of sensors may include one or more of: one or more LiDAR sensors, one or more RADAR sensors, or one or more camera sensors. By way of a non-limiting example, the unsafe maneuver and the type of unsafe maneuver may be determined using a neural network-based approach or machine learning techniques. Details of machine learning techniques, for example, training machine learning techniques using training database, are disclosed herein, and accordingly, those details are not repeated for brevity. Further, the neural network-based approach may include using a deep learning neural network or a CNN.

The method operations include determining 404 whether a risk assessment profile for the vehicle exists in a database. As described herein, the database is communicatively coupled with the at least one processor. Whether the risk assessment profile for the vehicle exists in the database is determined upon determining that a driver of the vehicle is performing the unsafe maneuver and the type of unsafe maneuver includes one or more of: (i) swerving without causing a lane change; (ii) a large amount of acceleration or deceleration; (iii) tailgating; (iv) changing a lane in a middle of an intersection; (v) changing a lane without a turn signal indication; (vi) driving above a posted speed limit by a threshold speed; (vii) driving below the posted speed limit by another threshold speed; (viii) large speed differentials compared to speed of other vehicles on a road; and (ix) a frequent lane changes over a predetermined time duration. The risk assessment profile is indexed in the database by one or more vehicle identifications of the vehicle including, but not limited to, a color of the vehicle, a make and a model of the vehicle, or a license plate of the vehicle. Accordingly, using the sensor data from the plurality of sensors, for example, from one or more camera sensors, the make and model of the vehicle, or the license plate of the vehicle that is determined to be performing an unsafe maneuver, are determined, and used for searching the risk assessment profile of the vehicle.

Upon determining that the risk assessment profile for the vehicle does not exist in the database, the method operations include generating 406 the risk assessment profile for the vehicle and computing 408 a threat assessment score. The risk assessment profile is generated to include data corresponding to the unsafe maneuver and the type of unsafe maneuver. The data corresponding to the unsafe maneuver includes sensors data in which an incidence of the unsafe maneuver is captured or recorded. Accordingly, the data corresponding to the unsafe maneuver includes sensor data of the one or more LiDAR sensors, one or more RADAR sensors, or one or more camera sensors. Accordingly, the data corresponding to unsafe maneuver saved in the risk assessment profile may be used for training the machine learning techniques described herein. Additionally, or alternatively, a timestamp when the unsafe maneuver and the type of unsafe maneuver occurred are stored in the risk assessment profile. For each type of unsafe maneuver, an occurrence of the unsafe maneuver is removed or deleted from the risk assessment profile when a predetermined time duration is passed without the specific type of unsafe maneuver being repeated by a driver of the vehicle. Further, when the unsafe maneuver for the type of unsafe maneuver repeated, a count of a respective type of unsafe maneuver is updated to compute 408 the threat assessment score. In other words, historical data stored in the risk assessment profile is updated to remove or delete data corresponding to the type of unsafe maneuver and the timestamp when the type of unsafe maneuver was performed upon lapse of a predetermined time duration for recomputing the threat assessment score based upon the updated historical data.

The threat assessment score is computed 408 based upon a total number of unsafe maneuvers for each of the one or more types of unsafe maneuver. For example, a driver of the vehicle may commit more than one types of unsafe maneuver such as, changing a lane without a turn signal indication and driving above a posted speed limit by a threshold speed, at the same time. Each of the one or more types of unsafe maneuver may be assigned a different risk score value. Accordingly, the threat assessment score may be computed based upon a respective score value for each of the one or more types of unsafe maneuver and a number of times each type of unsafe maneuver occurred, and total number of unsafe maneuvers. By way of an example, the threat assessment score (TAS) may be computed using Eq. 1 below. In Eq. 1 below, i, a, and b represent a number of types of unsafe maneuvers, a respective score value for a type of unsafe maneuver, and a number of times the type of unsafe maneuver occurred or present in the risk assessment profile that currently exists in the database.

$$T A S = \frac{{\sum }_{i = 1}^{n} ( {a}_{i} \times {b}_{i} )}{Σ {b}_{i}} \qquad Eq . 1$$

Upon determining that the risk assessment profile for the vehicle exists in the database, the method operations include retrieving 410, from the risk assessment profile, historical data including a respective timestamp of one or more types of unsafe maneuver and the one or more types of unsafe maneuver, updating 412 the historical data to further include data corresponding to the type of unsafe maneuver and the timestamp when the type of unsafe maneuver was performed or occurred, and computing 414 the threat assessment score that is revised based upon updated historical data. The threat assessment score is computed 414 using Eq. 1 above.

The method operations include performing 416 an action that increase safety of the autonomous vehicle upon determined that the TAS is at or above a threshold value. The action may include one or more of changing a lane in which the autonomous vehicle is driving, increasing distance between the autonomous vehicle and the vehicle performing an unsafe maneuver, parking the autonomous vehicle at a safe stop, and reporting the vehicle to a law enforcement agency. By way of a non-limiting example, there may be different threshold values, and different action may be taken based upon a value of the TAS.

An example technical effect of the methods, systems, and apparatus described herein includes at least improving safety of an autonomous vehicle as the autonomous vehicle can plan to operate in a manner that increases distance from the vehicle identified as being driven by a driver having a threat assessment score at or above a specific threshold value.

Some embodiments involve the use of one or more electronic processing or computing devices. As used herein, the terms “processor” and “computer” and related terms, e.g., “processing device,” and “computing device” are not limited to just those integrated circuits referred to in the art as a computer, but broadly refers to a processor, a processing device or system, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processor (DSP), an application specific integrated circuit (ASIC), and other programmable circuits or processing devices capable of executing the functions described herein, and these terms are used interchangeably herein. These processing devices are generally “configured” to execute functions by programming or being programmed, or by the provisioning of instructions for execution. The above examples are not intended to limit in any way the definition or meaning of the terms processor, processing device, and related terms.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a program, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random-access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein, including the implementation or utilization of components of the systems or steps independently and separately from other described components or steps. Therefore, it is manifestly intended that embodiments described herein be limited only by the claims.

What is claimed is:

1. A system positioned in an autonomous vehicle, the system comprising:
a plurality of sensors;
at least one memory configured to store instructions; and
at least one processor coupled to the at least one memory and configured to execute the stored instructions to perform operations comprising:
based upon sensor data from the plurality of sensors, determining an unsafe maneuver and a type of unsafe maneuver of a vehicle;
determining whether a risk assessment profile for the vehicle exists in a database, wherein the database is communicatively coupled with the at least one processor;
upon determining that the risk assessment profile for the vehicle does not exist in the database,
generating the risk assessment profile for the vehicle, wherein the risk assessment profile comprises data corresponding to the unsafe maneuver and the type of unsafe maneuver, one or more vehicle identifications of the vehicle, and a timestamp when the unsafe maneuver and the type of unsafe maneuver was performed; and
computing a threat assessment score based upon the type of unsafe maneuver;
upon determining the risk assessment profile for the vehicle exists in the database,
retrieving, from the risk assessment profile, historical data including a respective timestamp of one or more types of unsafe maneuver and the one or more types of unsafe maneuver;
updating the historical data to further include data corresponding to the type of unsafe maneuver and the timestamp when the type of unsafe maneuver was performed; and
computing the threat assessment score that is revised based upon updated historical data; and
upon determining that the threat assessment score is at or above a threshold value, performing an action that increase safety of the autonomous vehicle.

2. The system of claim 1, wherein the determining the unsafe maneuver and the type of unsafe maneuver comprises determining the unsafe maneuver and the type of unsafe maneuver using a neural network-based approach or machine learning techniques.

3. The system of claim 2, wherein the neural network-based approach includes using a deep learning neural network or a convolutional neural network.

4. The system of claim 1, wherein the risk assessment profile is indexed by the one or more vehicle identifications of the vehicle.

5. The system of claim 1, wherein the type of unsafe maneuver comprises swerving without causing a lane change, a large amount of acceleration or deceleration, tailgating, changing a lane in a middle of an intersection, changing a lane without a turn signal indication, driving above a posted speed limit by a threshold speed, driving below the posted speed limit by another threshold speed, large speed differentials compared to speed of other vehicles on a road, or a frequent lane changes over a predetermined time duration.

6. The system of claim 1, wherein the at least one processor is further configured to:
update the historical data to remove or delete data corresponding to the type of unsafe maneuver and the timestamp when the type of unsafe maneuver was performed upon lapse of a predetermined time duration; and
recompute the threat assessment score to revise based upon the updated historical data.

7. The system of claim 1, wherein computing the revised threat assessment score based upon updated historical data comprises computing the revised threat assessment score based on a total number of unsafe maneuvers for each of the one or more types of unsafe maneuver.

8. A computer-implemented method comprising:
determining, based upon sensor data from a plurality of sensors, an unsafe maneuver and a type of unsafe maneuver of a vehicle;
determining whether a risk assessment profile for the vehicle exists in a database;
upon determining that the risk assessment profile for the vehicle does not exist in the database,
generating the risk assessment profile for the vehicle, wherein the risk assessment profile comprises data corresponding to the unsafe maneuver and the type of unsafe maneuver, one or more vehicle identifications of the vehicle, and a timestamp when the unsafe maneuver and the type of unsafe maneuver was performed; and
computing a threat assessment score based upon the type of unsafe maneuver;
upon determining the risk assessment profile for the vehicle exists in the database,
retrieving, from the risk assessment profile, historical data including a respective timestamp of one or more types of unsafe maneuver and the one or more types of unsafe maneuver;
updating the historical data to further include data corresponding to the type of unsafe maneuver and the timestamp when the type of unsafe maneuver was performed; and
computing the threat assessment score that is revised based upon updated historical data; and
upon determining that the threat assessment score is at or above a threshold value, performing an action that increase safety of an autonomous vehicle.

9. The computer-implemented method of claim 8, wherein the determining the unsafe maneuver and the type of unsafe maneuver comprises determining the unsafe maneuver and the type of unsafe maneuver using a neural network-based approach or machine learning techniques.

10. The computer-implemented method of claim 9, wherein the neural network-based approach includes using a deep learning neural network or a convolutional neural network.

11. The computer-implemented method of claim 8, wherein the risk assessment profile is indexed by the one or more vehicle identifications of the vehicle.

12. The computer-implemented method of claim 8, wherein the type of unsafe maneuver comprises swerving without causing a lane change, a large amount of acceleration or deceleration, tailgating, changing a lane in a middle of an intersection, changing a lane without a turn signal indication, driving above a posted speed limit by a threshold speed, driving below the posted speed limit by another threshold speed, large speed differentials compared to speed of other vehicles on a road, or a frequent lane changes over a predetermined time duration.

13. The computer-implemented method of claim 8, further comprising:
updating the historical data to remove or delete data corresponding to the type of unsafe maneuver and the timestamp when the type of unsafe maneuver was performed upon lapse of a predetermined time duration; and
recomputing the threat assessment score to revise based upon the updated historical data.

14. The computer-implemented method of claim 8, wherein computing the revised threat assessment score based upon updated historical data comprises computing the revised threat assessment score based on a total number of unsafe maneuvers for each of the one or more types of unsafe maneuver.

15. An autonomous vehicle comprising:
a plurality of sensors;
at least one memory configured to store instructions; and
at least one processor coupled to the at least one memory and configured to execute the stored instructions to perform operations comprising:
based upon sensor data from the plurality of sensors, determining an unsafe maneuver and a type of unsafe maneuver of a vehicle;
determining whether a risk assessment profile for the vehicle exists in a database, wherein the database is communicatively coupled with the at least one processor;
upon determining that the risk assessment profile for the vehicle does not exist in the database,
generating the risk assessment profile for the vehicle, wherein the risk assessment profile comprises data corresponding to the unsafe maneuver and the type of unsafe maneuver, one or more vehicle identifications of the vehicle, and a timestamp when the unsafe maneuver and the type of unsafe maneuver was performed; and
computing a threat assessment score based upon the type of unsafe maneuver;
upon determining the risk assessment profile for the vehicle exists in the database,
retrieving, from the risk assessment profile, historical data including a respective timestamp of one or more types of unsafe maneuver and the one or more types of unsafe maneuver;
updating the historical data to further include data corresponding to the type of unsafe maneuver and the timestamp when the type of unsafe maneuver was performed; and
computing the threat assessment score that is revised based upon updated historical data; and
upon determining that the threat assessment score is at or above a threshold value, performing an action that increase safety of the autonomous vehicle.

16. The autonomous vehicle of claim 15, wherein the determining the unsafe maneuver and the type of unsafe maneuver comprises determining the unsafe maneuver and the type of unsafe maneuver using a neural network-based approach or machine learning techniques, wherein the neural network-based approach includes using a deep learning neural network or a convolutional neural network.

17. The autonomous vehicle of claim 15, wherein the risk assessment profile is indexed by the one or more vehicle identifications of the vehicle.

18. The autonomous vehicle of claim 15, wherein the type of unsafe maneuver comprises swerving without causing a lane change, a large amount of acceleration or deceleration, tailgating, changing a lane in a middle of an intersection, changing a lane without a turn signal indication, driving above a posted speed limit by a threshold speed, driving below the posted speed limit by another threshold speed, large speed differentials compared to speed of other vehicles on a road, or a frequent lane changes over a predetermined time duration.

19. The autonomous vehicle of claim 15, wherein the at least one processor is further configured to:
update the historical data to remove or delete data corresponding to the type of unsafe maneuver and the timestamp when the type of unsafe maneuver was performed upon lapse of a predetermined time duration; and
recompute the threat assessment score to revise based upon the updated historical data.

20. The autonomous vehicle of claim 15, wherein computing the revised threat assessment score based upon updated historical data comprises computing the revised threat assessment score based on a total number of unsafe maneuvers for each of the one or more types of unsafe maneuver.
